(19) United States
(12) Patent Application Publication
(10) Pub. No.: US 2007/0037027 A1
(43) Pub. Date: Feb. 15, 2007

(54) Fuel cell power plant

(76) Inventor: Atsushi Oma, Kanagawa (JP)

Correspondence Address: MCDERMOTT WILL & EMERY LLP, 600 13TH STREET, N.W., WASHINGTON, DC, 20005-3096, US

(21) Appl. No.: 10/572,560

(22) PCT Filed: Aug. 16, 2004
(86) PCT No.: PCT/JP04/12031

§ 371 Date: Mar. 17, 2006

(30) Foreign Application Priority Data
Sep. 19, 2003 (JP) 2003-328645

(51) Int. Cl. H01M 8/04

(52) U.S. Cl. 429/26; 429/24

(57) ABSTRACT

A fuel cell power plant comprises a fuel cell (37) which generates power by an electrochemical reaction between hydrogen supplied to an anode (32A) and oxygen supplied to a cathode (32B) via an electrolyte membrane (32). After the fuel cell (37) has stopped power generation, a cooling device (40, 41) condenses water vapor which has accumulated around the anode (32A). The condensed water prevents hydrogen remaining at the anode (32A) after the fuel cell (37) stops generating power, from burning. The cooling device (40, 41) performs cooling until the fuel cell (37) falls to a predetermined temperature, and then stops operating.

### FIELD OF THE INVENTION

This invention relates to preventing the combustion of hydrogen remaining at an anode after a fuel cell has stopped power generation.

### BACKGROUND OF THE INVENTION

When a power plant using a polymer electrolyte membrane stops operating, and air enters the anode, hydrogen remaining at the anode may give rise to a combustion reaction with oxygen in the air in a process in which the fuel cell is lowered to room temperature. This combustion reaction may cause wear or loss of the polymer electrolyte membrane.

Tokkai Hei 6-251788 published in 1994, JP2002-008701A published in 2002 and JP2000-164233A published in 2000 respectively by the Japanese Patent Office disclose a device which purges the hydrogen remaining at the anode using an inert gas or water when the power plant has stopped power generation.

### SUMMARY OF THE INVENTION

The purging device requires a pipe for supplying the gas or water used for purging, to the anode. When an inert gas is used as the purging gas, the power plant must be provided with a tank for storing the inert gas. If water vapor is used, a water vapor generation device is also required. If burnt gas is used as the purging gas, carbon dioxide or carbon monoxide contained in the burnt gas remains at the anode, and this may temporarily cause a drop in power output when the fuel cell is restarted.

Hence, in a power plant for a vehicle with limited installation space, the device for purging residual hydrogen was associated with considerable cost.

It is therefore an object of this invention to prevent the combustion reaction of residual hydrogen at the anode by a method other than purging.

In order to achieve the above object, this invention provides a fuel cell power plant comprising a fuel cell that comprises an anode, a cathode, and an electrolyte membrane gripped therebetween. The fuel cell generates an electric power by an electrochemical reaction through the electrolyte membrane of hydrogen supplied to the anode and oxygen supplied to the cathode. The power plant further comprises a device which condenses water vapor staying around the anode after the fuel cell has stopped power generation.

The details as well as other features and advantages of this invention are set forth in the remainder of the specification and are shown in the accompanying drawings.

### BRIEF DESCRIPTION OF THE DRAWINGS

FIG. 1 is a schematic diagram of a polymer electrolyte fuel cell.

FIG. 2 is a plan view of a membrane electrode assembly of the polymer electrolyte fuel cell.

FIG. 3 is a plan view of a separator of the polymer electrolyte fuel cell.

FIG. 4 is an exploded longitudinal sectional view of the polymer electrolyte fuel cell.

FIG. 5 is a longitudinal sectional view of a polymer electrolyte fuel cell stack.

FIG. 6 is a schematic diagram of a fuel cell power plant according to this invention.

FIG. 7 is a flowchart describing a power generation stop routine performed by a controller according to this invention.

FIG. 8 is a schematic diagram of a fuel cell power plant according to a second embodiment of this invention.

FIG. 9 is a schematic diagram of a fuel cell power plant according to a third embodiment of this invention.

FIG. 10 is a flowchart describing a power generation stop routine performed by a controller according to the third embodiment of this invention.

FIG. 11 is a schematic diagram of a fuel cell power plant according to a fourth embodiment of this invention.

FIG. 12 is a flowchart describing a power generation stop routine performed by a controller according to the fourth embodiment of this invention.

FIG. 13 is a schematic diagram of a fuel cell power plant according to a fifth embodiment of this invention.

FIG. 14 is a schematic diagram of a fuel cell power plant according to a sixth embodiment of this invention.

FIG. 15 is a flowchart describing a power generation stop routine performed by a controller according to the sixth embodiment of this invention.

### DESCRIPTION OF THE PREFERRED EMBODIMENTS

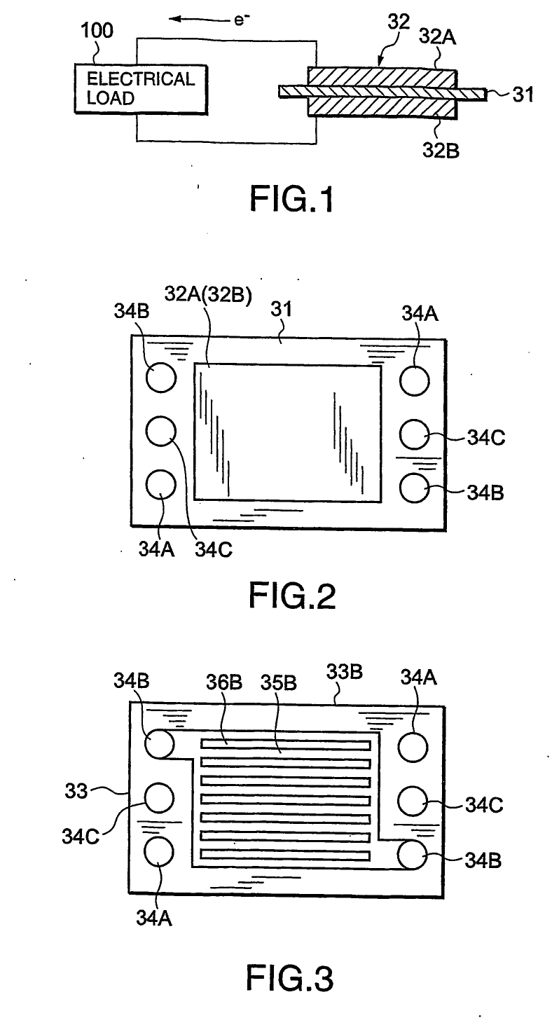

Referring to FIG. 1-FIG. 5, a fuel cell will first be described. The fuel cell shown in the figures is identical to that shown in the prior art.

Referring to FIG. 1, the main body of the fuel cell comprises a membrane electrode assembly 32 wherein an electrolyte membrane 31 comprising a perfluorocarbon sulfonate film sheet is gripped by an anode 32A and cathode 32B, which are a pair of thin plate gas diffusion electrodes having platinum or the like as a catalyst.

Referring to FIG. 2, to prevent mixing of hydrogen supplied to the anode 32A and air supplied to the cathode 32B, the surface area of the electrolyte membrane 31 is set to be larger than the surface area of the anode 32A and cathode 32B.

Hydrogen is supplied to the anode 32A. At the anode 32A, the following reaction takes place:
H₂→2H⁺+2e⁻

Air is supplied to the cathode 32A. Regarding fuel cells for vehicle installation, pure hydrogen (H₂) is often supplied to the anode 32A, but hydrogen-rich gas obtained by reforming hydrocarbon fuels such as methanol or gasoline may also be supplied to the anode 32A

At the cathode 32B, the following reaction takes place due to the oxygen in the air:

$$2 {H}^{+} + 2 {e}^{-} + \frac{1}{2} {O}_{2} \to {H}_{2} O$$

The protons 2H⁺ generated at the anode 32 pass through the electrolyte membrane 31 to reach the cathode 32B. The electrons 2e⁻ cannot pass through the electrolyte membrane 31, but travel from the anode 32A via the electrical wiring through an electrical load 100 to reach the cathode 32B. As a result, electricity is supplied to the electrical load 100.

At the cathode 32B, the protons 2H⁺ which pass through the electrolyte membrane 31, the electrons 2e⁻ which pass through the electrical wiring and oxygen O₂ in the air react together to produce water (H₂O). This water is referred to as produced water. Most of the produced water vaporizes in the air supplied to the cathode 32A, and is discharged to the outside together with unreacted components in the air.

On the other hand, the produced water also easily collects in the gas diffusion electrodes 32A, 32B. The produced water which has collected in the gas diffusion electrodes 32A, 32B blocks the diffusion of hydrogen or air, and causes a drop in the power generating performance of the fuel cell. It is therefore necessary to design the gas diffusion electrodes 32A, 32B so that produced water does not easily accumulate and gas diffuses easily.

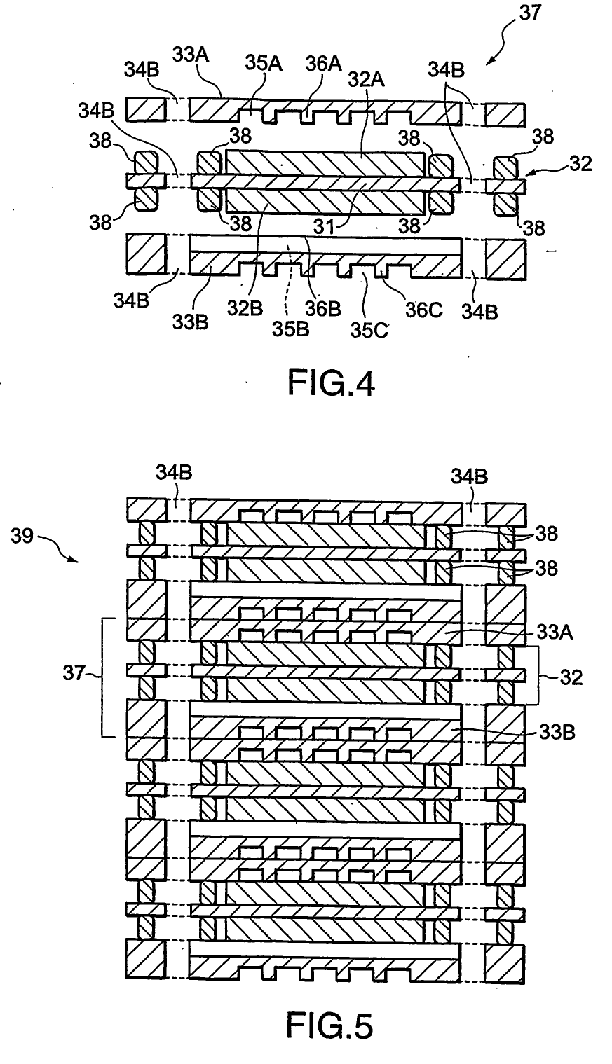

Referring to FIG. 4, in order to connect the gas diffusion electrodes 32A, 32B to the electrical wiring, plates having a charge collecting function are respectively installed outside the gas diffusion electrodes 32A, 32B. This plate will be referred to as a separator 33.

The separator 33, to prevent mixing between hydrogen and air, must be constructed of such a material that it does not allow passage of gas, and has electrical conduction properties for the purpose of collecting charge. This separator 33 is therefore generally constructed of a material having a metal or carbon as its principal component. The separator 33 in contact with the anode 32A comprises plural groove-shaped hydrogen passages 35A on the surface facing the anode 32A. The separator 33 in contact with the cathode 32B has plural groove-shaped air passages 35B as shown in FIG. 3 on the surface facing the cathode 32B, and plural groove-shaped coolant passages 35C for cooling the heat produced by the electrochemical reaction at the cathode 32B on the rear surface. The coolant passages 35C contain pure water or a liquid obtained by adding an antifreeze to pure water. As shown in FIG. 4, the grooves in the hydrogen passages 35A and coolant passages 35C are parallel, and the grooves in the air passages 35B are formed perpendicular thereto.

Referring to FIG. 3, pairs of throughholes 34A-34C are respectively formed at positions in the separator 33 such that they do not the overlap with the anode 32A and cathode 32B.

The pair of throughholes 34A have the functions of distributing hydrogen to the hydrogen passages 35A, and discharging gas remaining after the reaction at the anode 32A as anode effluent from the hydrogen passages 35A. The pair of throughholes 34B have the functions of supplying air to the air passages 35B and discharging the gas remaining after the reaction at the cathode 32B and part of the produced water as cathode effluent. The pair of throughholes 34C have the role of supplying coolant to the coolant passages 35, and discharging coolant after the fuel cell has been cooled from the coolant passages 35C.

As shown in FIG. 3, the air passages 35B are formed by plural parallel grooves which join one of the throughholes 34B and the other throughhole 34B. These grooves are separated by ribs 36B. The hydrogen passages 35A are also formed by plural parallel grooves which join one of the throughholes 34A and the other throughhole 34A, the direction of these grooves being perpendicular to the grooves of the air passages 35B as shown in FIG. 4. The grooves of the hydrogen passages 35A are separated by ribs 36A.

The coolant passages 35C are formed by plural parallel grooves separated by ribs 36C. The grooves of the coolant passages 35C are formed in an identical direction to the grooves of the hydrogen passages 35A.

The ribs 36A-36C form part of the separators 33. The charge collection function of the separators 33 is achieved by the ribs 36A-36C. Packing 38 is gripped between the separators 33 and the membrane electrode assembly 32.

As described above, a single fuel cell 37 is formed by the membrane electrode assembly 32 and the pair of separators 33 disposed on its two sides.

Referring to FIG. 5, a fuel cell stack 39 is formed by stacking plural fuel cells 37 in one direction. The generated voltage of one fuel cell 37 is as low as one volt or less, so plural fuel cells 37 must be connected in series in order to obtain the required startup power. As a result, the fuel cell power plant uses the fuel cell stack 39 which comprises plural fuel cells 37 stacked together.

When the fuel cells 37 are stacked together, the throughholes 34A, 34B and 34C pass through the fuel cell stack 39 in the stacking direction of the fuel cell stack 39 so that hydrogen, air and coolant passages sealed by the packing 38 are respectively formed. These sealed passages are referred to as manifolds.

This invention relates to a vehicle power plant which uses the fuel cell stack 39 having the aforesaid construction.

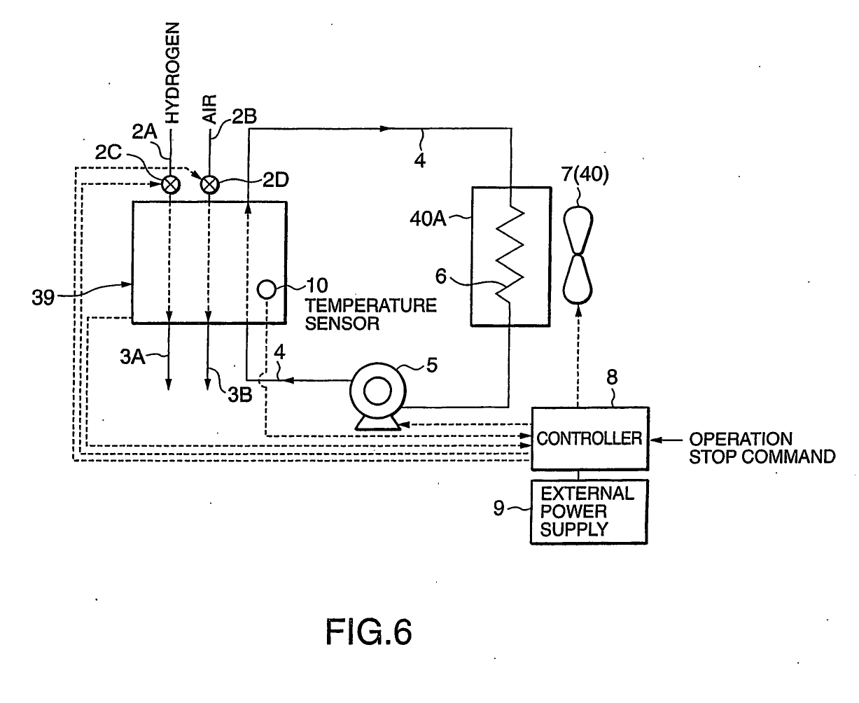

Referring to FIG. 6, the power plant comprises a hydrogen supply pipe 2A which supplies hydrogen to the hydrogen manifold of the fuel cell stack 39, and an anode effluent pipe 3A which discharges anode effluent from the hydrogen manifold. An air supply pipe 2B which supplies air to the air manifold of the fuel cell stack 39, and a cathode effluent pipe 3B which discharges cathode effluent from the air manifold are provided. A cooling device 40 which recirculates coolant to the coolant manifold of the fuel cell stack 39 is further provided.

A shutoff valve 2C which stops hydrogen supply to the fuel cell stack 39 is installed in the hydrogen supply pipe 2A, and a shutoff valve 2D which stops air supplied to the fuel cell stack 39 is installed in the air supply pipe 2B. The shutoff valves 2C, 2D open and close according to an open/close signal output by a controller 8.

The cooling device 40 comprises a recirculation passage 4 connected to the coolant manifold of the fuel cell stack 39.

A pump 5 and a tank 40A which incorporates a radiator 6 are installed in the recirculation passage 4. The cooling device 40 further comprises a fan 7 for promoting heat discharge from the radiator 6.

Coolant supplied to the fuel cell stack 39 due to the operation of the pump 5 absorbs heat generated by the electrochemical reaction in the fuel cell stack 39 when it passes through the coolant passages 35C in the fuel cell stack 39.

The coolant discharged from the fuel cell stack 39 reaches the tank 40A, and discharges heat by heat exchange with the outside air in the heat exchanger 6 whereon air is blown by the fan 7. The coolant whereof the temperature has been lowered in the tank 40A, is again supplied to the fuel cell stack 39 by the pump 5. In this embodiment, the pump 8 and tank 40A are disposed such that the coolant flow direction in the coolant manifold is opposite to the hydrogen flow direction in the hydrogen manifold and the air flow direction in the air manifold.

The starting and stopping of the pump 5 and fan 7, and the rotation speeds of the pump 5 and fan 7, are controlled by the controller 8.

Due to these controls, the controller 8 maintains the temperature of the fuel cell stack 39 during power generation within a range between about 60 degrees Centigrade to 90 degrees Centigrade.

The power plant has access from the fuel cell stack 39 to a separate external power supply 9. When the fuel cell stack is not generating power, the external power supply 9 can supply power to the pump 5 and fan 7. The power required to operate the controller 8 is also supplied from the external power supply 9. A separate fuel cell power plant can be used as the external power supply 9.

The controller 8 comprises a microcomputer having a central processing unit (CPU), read-only memory (ROM), random access memory (RAM) and input/output interface (I/O interface). The controller may also comprise plural microcomputers.

The power plant comprises a temperature sensor 10 which detects the temperature of the fuel cell stack 39. Signals denoting output voltages are also input from the fuel cell stack 39 to the controller 8.

When the fuel cell stack 39 is generating power, the controller 8 operates the pump 5 and fan 7 using power supplied from the fuel cell stack 39 based on the temperature detected by the temperature sensor 10. After the fuel cell stack 39 stops power generation, the pump 5 and fan 7 are operated using power supplied from the external power supply 9 based on the temperature detected by the temperature sensor 10.

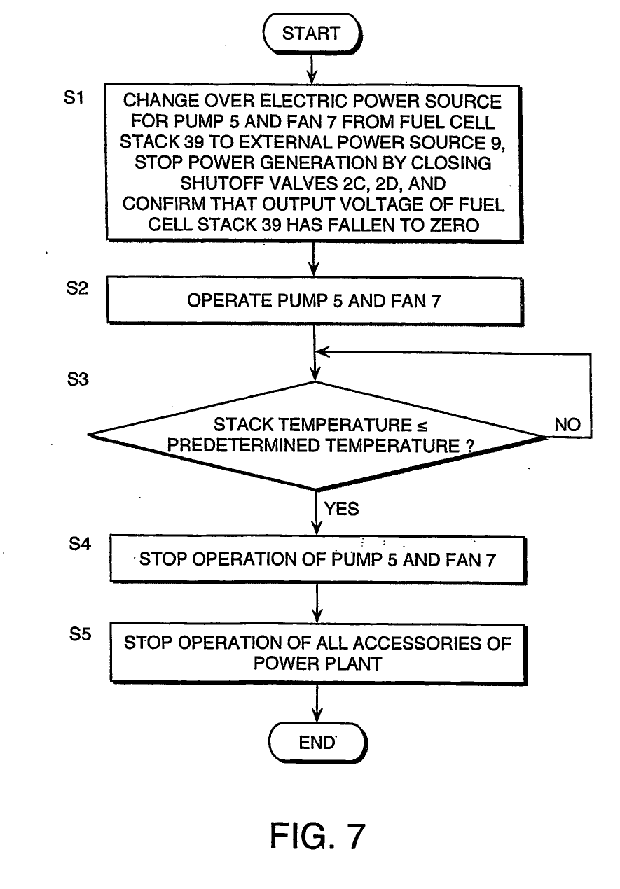

Next, referring to FIG. 7, the power generation stop routine executed by the controller 8 when the fuel cell stack 39 stops power generation, will be described. This routine is performed when a power generation stop command is input into the controller 8 as a trigger from outside.

First, in a step S1, the controller 8 changes over the power supply source for supplying current to drive the pump 5 and fan 7 from the fuel cell stack 39 to the external power supply 9, and closes the shutoff valves 2C, 2D. Due to this operation, hydrogen and air supply to the fuel cell stack 39 stops, and the fuel cell stack 39 stops generating power. During this time, the controller 8 monitors the output voltage of the fuel cell stack 39, and when it is found that the output voltage has fallen to zero, it performs the processing of a next step S2.

In the step S2, the controller 8 operates the pump 5 and fan 7 using power supplied from the external power supply 9. If the pump 5 and fan 7 were operating before power generation was stopped, the operation of the pump 5 and fan 7 is continued using the power supplied from the external power supply 9.

Due to the operation of the pump 5, coolant in the tank 40A is supplied to the fuel cell stack 39 via the recirculation passage 4. Coolant continues to flow through the coolant passages 35C in the fuel cell stack 39 so as to cool the fuel cell stack 39. As a result, water vapor remaining in the hydrogen passage 35A and air passage 35B condenses, and liquid water is produced inside the gas diffusion electrodes as well as in the vicinity of the catalyst. Also, the temperature of hydrogen remaining in the hydrogen passages 35A and air remaining in the air passages 35B falls due to the cooling, and the pressure of these gases also falls. The condensed water which has collected on the surface or in the vicinity of the catalyst prevents the residual hydrogen from reacting with air and burning. Therefore, after the operation of the fuel cell stack 39 has stopped, even if outside air enters the hydrogen passages 35A from the anode effluent pipe 3A, the residual hydrogen does not burn.

In a next step S3, the controller 8 determines whether or not the temperature of the fuel cell stack 39 detected by the temperature sensor 10 has fallen to a predetermined temperature. When the average of the fuel cell stack 39 is higher than the predetermined temperature, the controller 8 reads the temperature of the fuel cell stack 39, and repeats the comparison of the read temperature with the predetermined temperature. The predetermined temperature is determined in advance based on a partial pressure curve of saturated water vapor, but the predetermined temperature is preferably set to a temperature of 60 degrees Centigrade or less. Herein, the predetermined temperature is set to 60 degrees Centigrade.

When the temperature of the fuel cell stack 39 falls to the predetermined temperature, the controller 8, in a step S4, stops the operation of the pump 8 and fan 7.

In a next step S5, the controller 8 stops the operation of all accessories in the power plant. As a result, the power plant enters the full shutdown state. After the processing of the step S5, the controller 8 terminates the routine.

In this way, after the power plant has completely stopped operating, the gas temperature in the fuel cell stack 39 falls even more due to heat radiation. Therefore, even if outside air enters the hydrogen passages 35A of the fuel cell stack 39, the produced water on the surface and in the vicinity of the catalyst of the anode 32A prevents combustion of the residual hydrogen. In other words, combustion of the residual hydrogen can be completely prevented even if the residual hydrogen is not purged from the fuel cell stack 39.

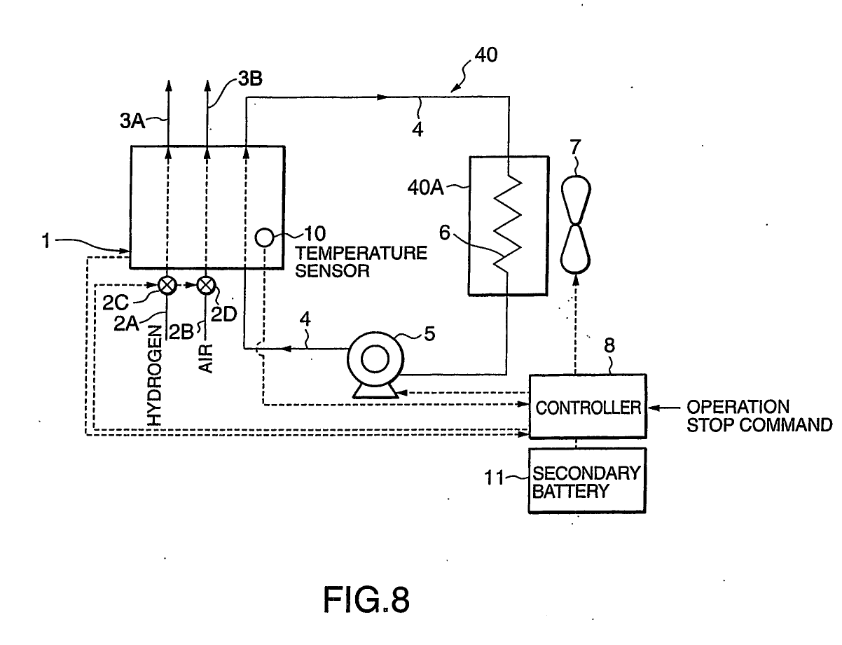

Next, a second embodiment of this invention will be described referring to FIG. 8.

Referring to FIG. 8, the power plant according to this embodiment uses a secondary battery 11 instead of the external power supply 9 of the first embodiment. The secondary battery 11 is charged using power generated by the fuel cell stack 39 while the fuel cell stack 39 is operating. On the other hand, when the power generation load of the fuel cell stack 39 increases sharply, the secondary battery 11 discharges power so as to supplement the power supply of the fuel cell stack 39.

In the power plant according to this embodiment, the air and hydrogen supply directions are set opposite to those of the first embodiment so that they are identical to the coolant flow direction.

The remaining features of the construction are identical to those of the first embodiment. In this embodiment also, the controller 8 executes an identical power generation stop routine to that of the first embodiment. However, in the step S1, the power supply is changed over not to the external power supply 9, but to the secondary battery 11.

According to this embodiment, the current which drives the pump 5 and fan 7 is supplied by the second battery 11, so there is no need for a power supply outside the power plant.

According to this embodiment also, the gas flow directions in the hydrogen manifold and air manifold are identical to the coolant flow direction in the coolant manifold. In the fuel cells 37 forming the fuel cell stack 39, in the upstream part of the hydrogen passages 35, the produced water due to the power generation reaction is small, and the produced water increases progressively downstream. The water content increases progressively downstream not only for the hydrogen passages 35A, but also for the anode 32A facing the hydrogen passages 35A and the electrolyte membrane 31.

In this embodiment, wherein the gas flow directions in the air manifold and hydrogen manifold are set identical to the coolant flow direction in the coolant manifold, in the fuel cell stack 39, there is a high probability that the coolant which cools the upper part of the hydrogen passages 35A is at a lower temperature than the coolant which cools the lower part of the hydrogen passages 35A. In other words, the upper part is cooled more than the lower part of the hydrogen passages 35A, and consequently condensation of water vapor in the upper part of the hydrogen passages 35A is promoted.

On the other hand, the flow rate of hydrogen in the hydrogen passage 35A is less than the flow rate of air in the air passage 35B, and as a result the humidity in the outlet of the hydrogen passage 35A is high. So the condensation is more likely to occur in the lower part of the hydrogen passage 35A than in the upper part thereof.

By promoting condensation in the upper part of the hydrogen passage 35A as described above, therefore, the distribution of condensed water in the hydrogen passage 35A can be averaged.

In this embodiment, a capacitor can be used instead of the secondary battery 11.

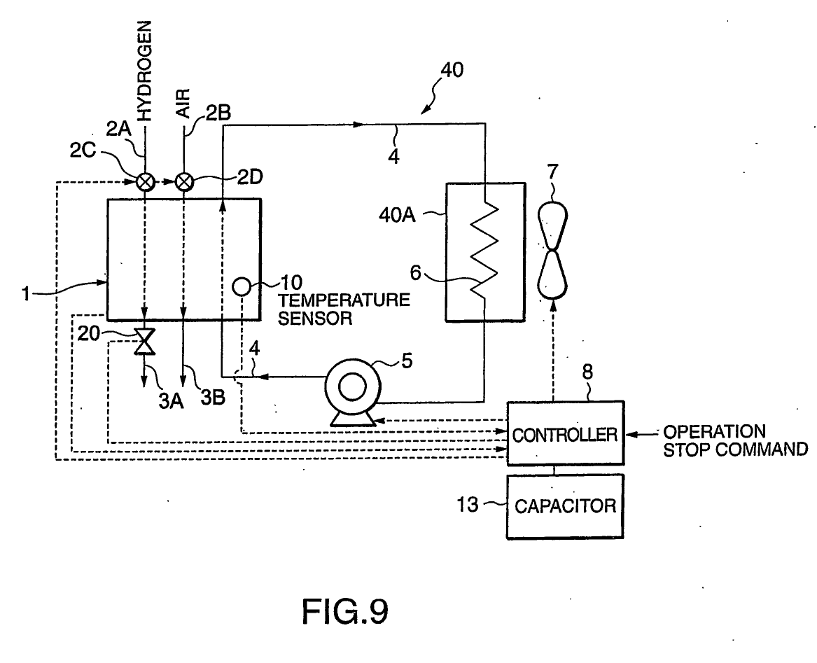

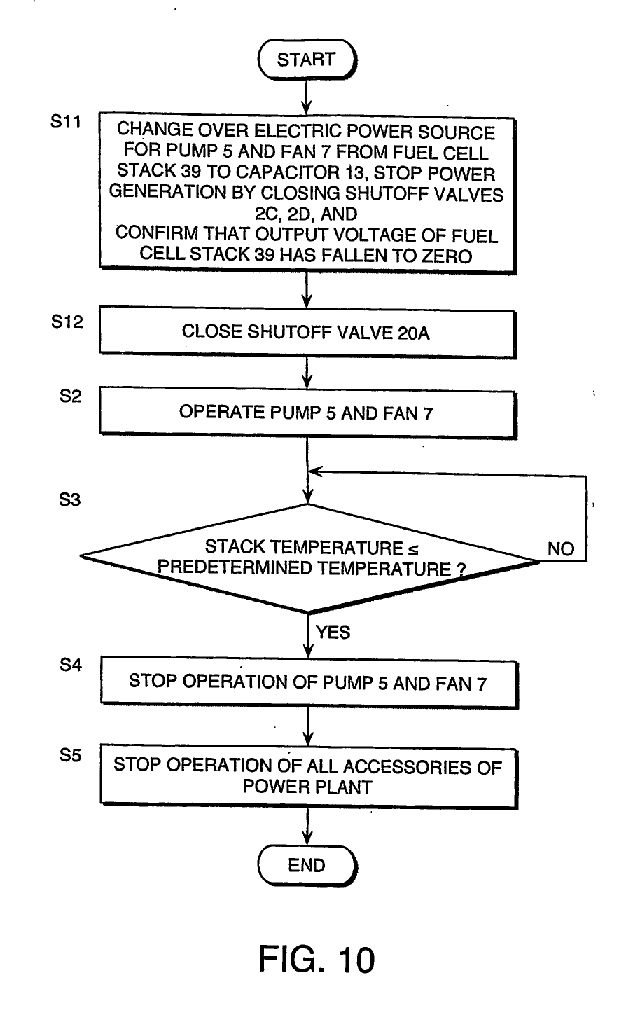

Next, referring to FIGS. 9 and 10, a third embodiment of this invention will be described.

Referring to FIG. 9, the power plant according to this embodiment comprises a capacitor 13 which functions as a power supply separate from the fuel cell stack 39, and comprises a shutoff valve 20 in the anode effluent pipe 3A which prevents air from being aspirated into the fuel cell stack 39. The remaining features of the hardware are identical to those of the power plant of the first embodiment.

Next, referring to FIG. 10, the power generation stop routine executed by the controller 8 when the fuel cell stack 39 stops power generation, will be described. This routine is executed when a power generation stop command is input into the controller 8 as a trigger from outside.

First, in a step S11, the controller 8 changes over the power supply source which supplies drive current to the pump 5 and fan 7, from the fuel cell stack 39 to the capacitor 13, and closes the shutoff valves 2C, 2D. Due to this operation, hydrogen and air supply to the fuel cell stack 39 stops, and the fuel cell stack 39 stops power generation. During this interval, the controller 8 monitors the output voltage of the fuel cell stack 39, and verifies that the output voltage has fallen to zero.

In a next step S12, the controller 8 closes the shutoff valve 20 of the anode effluent pipe 3A. Due to the closure of the shutoff valve 20 entry of air from the anode effluent pipe 3A to the hydrogen manifold is prevented. The hydrogen remaining in the hydrogen passages 35A of the fuel cells 37 in this stage falls to a concentration at which power generation is not possible.

The processing of the steps S2-S5 is identical to that of the first embodiment.

According to this embodiment, after the fuel cell stack 39 has stopped power generation, even if the pressure in the hydrogen passages 35A falls due to cooling, entry of air from outside via the anode effluent pipe 3A to the hydrogen passages 35A is prevented by the shutoff valve 20. Therefore, combustion of residual hydrogen at the anode 32A can definitively be prevented after power generation has stopped.

In this embodiment, the pump 5 and fan 7 are operated after closing the shutoff valve 20. However, various possibilities exist regarding the timing with which the shutoff valve 20 is closed. Specifically, in FIG. 10, the step S12 can be moved after the step S4, so that the shutoff valve 20 closes after the pump 5 and fan 7 stop operating. Alternatively, the step S12 can be moved after the step S5, so that the shutoff valve 20 closes after the pump 5 and fan 7 operate.

In this embodiment, the external power supply 9 or secondary battery 11 can be used instead of the capacitor 13.

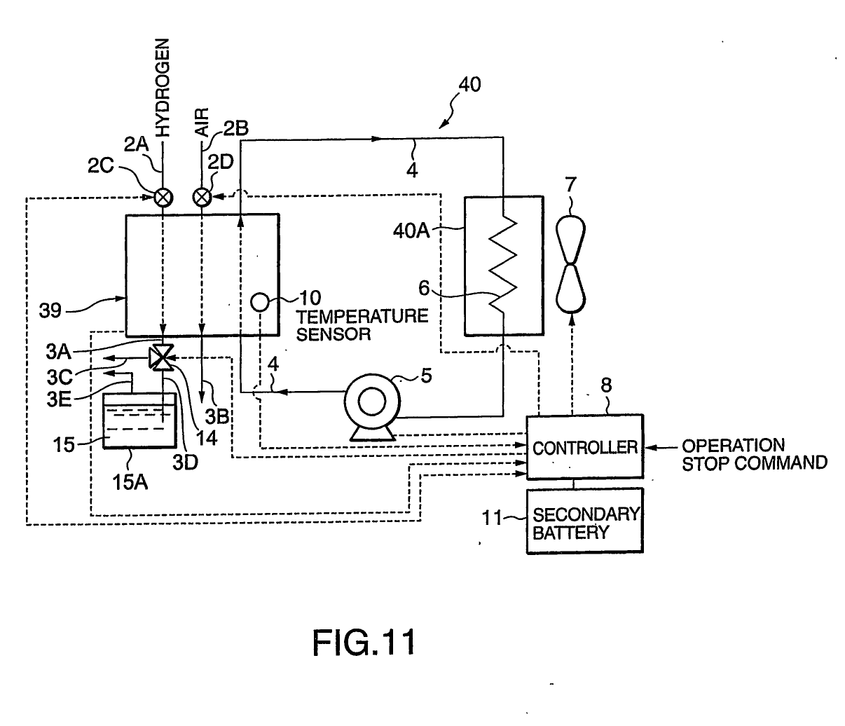

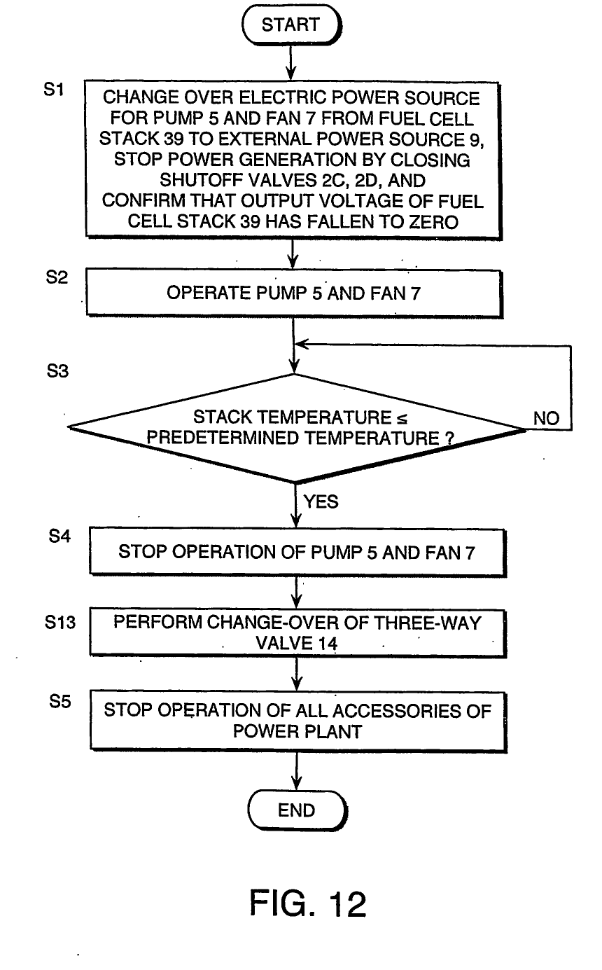

Next, referring to FIGS. 11 and 12, a fourth embodiment of this invention will be described.

Referring to FIG. 11, the power plant according to this embodiment further comprises a three-way valve 14 and a water trap 15 in addition to the construction of the first embodiment. The water trap 15 is connected to the anode effluent pipe 3A via a three-way valve 14. The water trap 15 comprises a container 15A for collecting water, and a pipe 3D leading off from the three-way valve 14 which opens into the water in the container 15A. The space above the water surface in the container 15A connects with the atmosphere via a pipe 3E. The three-way valve 14 is changed over between a section which opens the anode effluent pipe 3A to the atmosphere, and a section which connects it to the pipe 3D, by a change-over signal output by the controller 8.

In the section which opens the anode effluent pipe 3A to the atmosphere, the hydrogen manifold connects with the atmosphere via the anode effluent pipe 3A. When the power plant is operating, the three-way valve 14 is held at this section, and in the same way as in the first embodiment, discharged hydrogen is released into the atmosphere via. the anode effluent pipe 3A.

Even when the anode effluent pipe 3A is connected to the pipe 3D, if the pressure of the hydrogen manifold rises, the gas in the hydrogen manifold is discharged from the anode effluent pipe 3A via the water trap 15. However, if the pressure in the hydrogen manifold falls, entry of air from outside to the hydrogen manifold by the anode effluent pipe 3A is prevented by the water trap 15.

The remaining features of the hardware of the power plant are identical to those of the first embodiment.

Next, referring to FIG. 12, the power generation stop routine executed by the controller 8 when the fuel cell stack 39 stops power generation will be described. This routine is executed when a power generation stop command is input into the controller 8 as a trigger from outside.

The processing of the steps S1-S4 is identical to the steps S1-S4 of the first embodiment shown in FIG. 7.

After the pump 5 and fan 7 have stopped in the step S4, in a following step S13, the controller 8 changes over the three-way valve 14 between the section which opens the anode effluent pipe 3A to the atmosphere, and the section which connects the anode effluent pipe 3A to the pipe 3D. Subsequently, even if the pressure in the hydrogen manifold falls, entry of air from outside via the anode effluent pipe 3A to the hydrogen manifold is blocked by the water trap 15.

In a next step S5, as in the first embodiment, the controller 8 stops the operation of all accessories in the power plant.

In this embodiment also, as in the third embodiment, after the fuel cell stack 39 has stopped power generation, even if the pressure of the hydrogen passages 35A falls due to cooling, air is prevented from entering the hydrogen passages 35A from outside via the anode effluent pipe 35A by the water trap 15. Therefore, combustion of residual hydrogen at the anode 32A after power generation has stopped can be more definitively prevented. Further, according to this embodiment, if the pressure in the hydrogen passages 35A rises for some reason after the fuel cell stack 39 has stopped power generation, the excess pressure can be blown off to the atmosphere via the water trap 15.

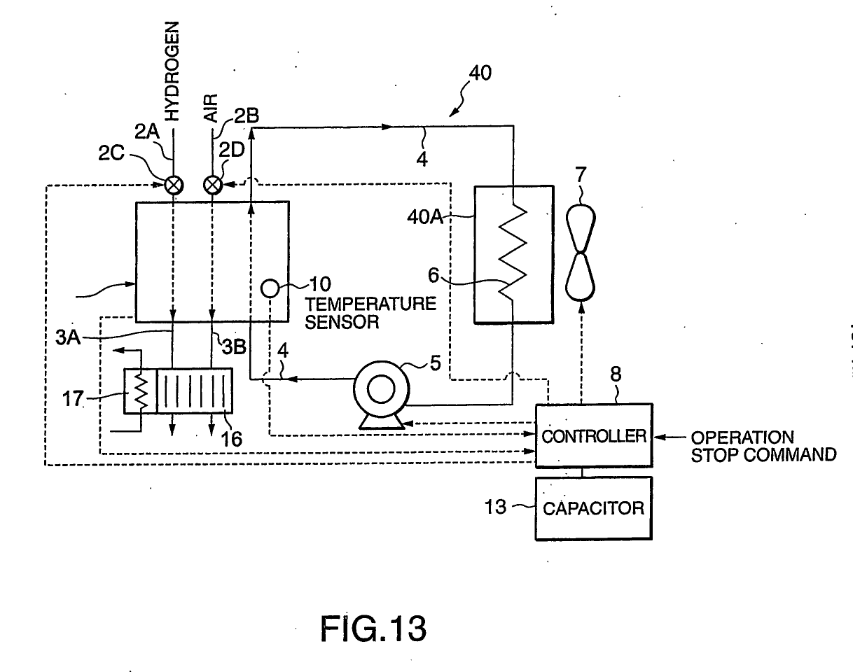

Next, referring to FIG. 13, a fifth embodiment of this invention will be described.

The power plant according to this embodiment is provided with a catalytic burner 16 in the anode effluent pipe 3A and cathode effluent pipe 3B instead of the shutoff valve 20 of the third embodiment. The catalytic burner 16 comprises a heat exchanger 17.

During normal power generation of the fuel cell stack 39, the catalytic burner 16 internally premixes anode effluent and cathode effluent discharged from the fuel cell stack 39 via the anode effluent pipe 3A and cathode effluent pipe 3B, burns the pre-mixed gas by a catalytic reaction catalyzed by a built-in oxidation catalyst, and discharges the burnt gas to the atmosphere. As a result, burnt gas is present in the downstream part of the catalyst burner 16.

After the fuel cell stack 39 has stopped power generation, the pressure in the hydrogen passages 35A falls due to heat radiation and cooling of the fuel cell stack 39. At this time, burnt gas in the downstream part of the catalyst burner 16 is aspirated into the hydrogen manifold and hydrogen passages 35A via the anode effluent pipe 3A, and air in the atmosphere is then aspirated into the hydrogen manifold and hydrogen passages 35A via the catalytic burner 16 and anode effluent pipe 3A. The catalyst in the catalytic burner 16 oxidizes carbon monoxide in the burnt gas to carbon dioxide. Also, if hydrogen remains in the burnt gas, this hydrogen is oxidized to water vapor.

When the power plant has stopped operating, the controller 8 executes the routine of FIG. 7 of the first embodiment.

According to this embodiment, if the pressure of the hydrogen manifold or hydrogen passages 35A falls after the fuel cell stack 39 has stopped operating, inert burnt gas wherefrom carbon monoxide or hydrogen has been removed is supplied to the hydrogen manifold and hydrogen passages 35A via the anode effluent pipe 3A, and air in the atmosphere is then supplied to the hydrogen manifold and hydrogen passages 35A. Therefore, if hydrogen remains in the hydrogen passages 35A, in the same way as the prevention of combustion of residual hydrogen by condensed water as in the first embodiment, combustion of residual hydrogen is even more definitively prevented by the inert gas which flows into the hydrogen manifold and hydrogen passages 35A.

In this embodiment also, as in the third embodiment, the external power supply 9 or secondary battery 11 may be used instead of the capacitor 13.

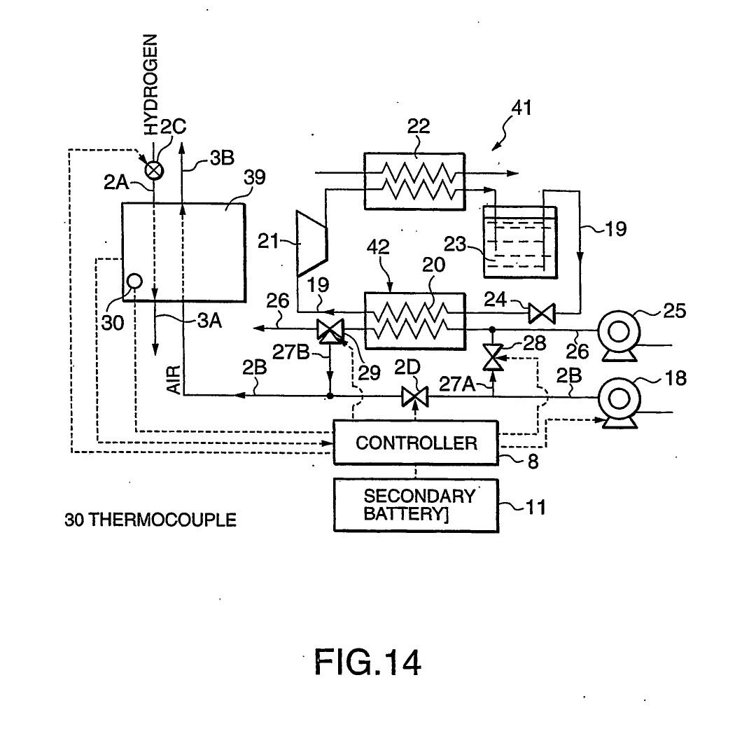

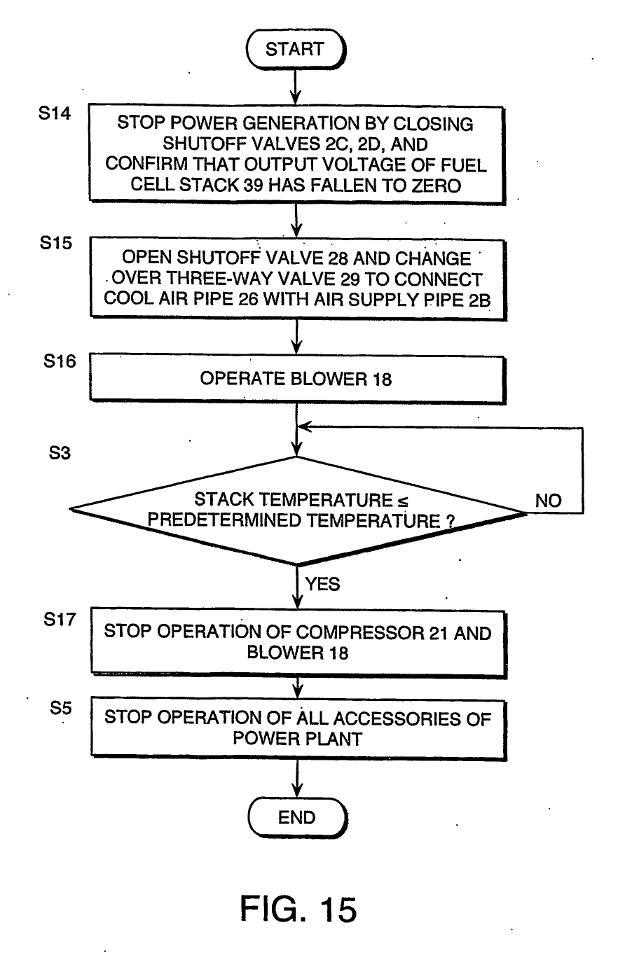

Next, referring to FIGS. 14 and 15, a sixth embodiment of this invention will be described.

Referring to FIG. 14, the power plant according to this embodiment is installed together with an air conditioning device 41 for the vehicle compartment.

The air conditioning device 41 comprises a heat exchange evaporator 20 which cools the vehicle compartment by capturing vaporization heat due to vaporization of coolant from the air in the vehicle, a compressor 21 which compresses coolant gas produced by vaporization, a condenser 22 which liquefies the compressed coolant gas, a tank 23 which collects the liquefied coolant and an expansion valve 24 which releases the expansion pressure of the coolant. The air conditioning device 41 further comprises a blower 25 which supplies air to the heat exchange evaporator 20 via a cooling air passage 26.

Air supplied to the heat exchange evaporator 20 from the blower 25 via the cooling air passage 26 is cooled by the coolant, and then ejected as cold air into the vehicle compartment via a three-way valve 29 installed in the cooling air passage 26.

When the vehicle is running, the three-way valve 29 opens the cooling air passage 26 to the vehicle compartment, and supplies cold air to the vehicle compartment. The three-way valve 29 further comprises a section which connects the cooling air passage 26 to the air supply pipe 2B of the power plant via a branch pipe 27B.

When the power plant is operating, air is supplied to the air supply pipe 2B from a blower 18 via a shutoff valve 2D which is normally open. The air supply pipe 2B upstream of the shutoff valve 2D and the cooling air passage 26 upstream of the heat exchange evaporator 20 are connected via a branch pipe 27A which branches off from the air supply pipe 2B, and a shutoff valve 28, normally closed, which is disposed in the branch pipe 27A.

The compressor 21 of the air conditioning device 41, blower 25 and blower 18 of the power plant are driven by the power generated by the power plant or power stored by the secondary battery 11. The power required to operate the shutoff valves 2D, 28 and the three-way valve 29 is also supplied by the power plant or secondary battery 11.

Regarding the fuel cell stack 39, according to this embodiment, the positions of the air supply pipe 2B and cathode effluent pipe 3B are opposite to those of the first embodiment so that air in the air manifold flows in a direction opposite to that of hydrogen flow in the hydrogen manifold. Also, to detect the temperature of the fuel cell stack 39, a thermocouple 30 is used instead of the temperature sensor 10 of the first embodiment. Further, in the power plant according to this embodiment, the coolant passages 35C are not formed in the fuel cells 37, and the recirculation passage 4, pump, fan 7 and tank 40A which recirculate coolant to the fuel cell stack 39, are omitted.

When the fuel cell stack 39 is generating power, air is supplied from the blower 18 to the air manifold and air passages 35B of the fuel cell stack 39 via the shutoff valve 2D and air supply pipe 2B. In the air conditioning device 41, air supplied from the blower 25 via the cooling air passage 26 is cooled by the heat exchange evaporator 20, and cold air is supplied to the vehicle compartment via the three-way valve 29 and the cooling air passage 26. In this state, the shutoff valve 28 is closed, the shutoff valve 2D is open, and the three-way valve 29 opens the cooling air passage 26 to the vehicle compartment.

When the fuel cell stack 39 stops power generation, the shutoff valves 2C, 2D are closed. The blower 25 of the air conditioning device 41 stops operating when the fuel cell stack 39 stops generating power. The controller 8 operates the shutoff valve 28 and three-way valve 29 based on the temperature of the fuel cell stack 39 detected by the thermocouple 30, so that air in the air supply pipe 2B passes through the heat exchange evaporator 20. In this state, the blower 18 is started, air from the blower 18 is cooled by the heat exchange evaporator 20, and is then supplied to the air supply pipe 2B.

Next, referring to FIG. 15, the power generation stop routine executed by the controller 8 when the fuel cell stack 39 stops operating, will be described. This routine is executed when a power generation stop command is input into the controller 8 as a trigger from outside.

First, in a step S14, the controller 8 closes the shutoff valves 2C, 2D. Due to this operation, hydrogen and air supply to the fuel cell stack 39 stops, and the fuel cell stack 39 stops power generation. When the fuel cell stack 39 stops power generation, the blower 25 stops operating. On the other hand, the compressor 21 continues operating due to the power supplied by the secondary battery 11. The controller 8 monitors the output voltage of the fuel cell stack 39, verifies that the output voltage has fallen to zero, and performs the processing of a next step S15.

In the step S15, the controller 8 opens the shutoff valve 28, and operates the three-way valve 29 so that the cooling air passage 26 is connected to the air supply pipe 2B via the branch pipe 27B.

In a next step S16, the controller 8 starts the blower 18 due to the power supplied by the secondary battery 11. After the air blown by the blower 18 passes through the branch pipe 27A and shutoff valve 28, and is cooled by the heat exchange evaporator 20, it is supplied to the air supply pipe 2B via the three-way valve 29 and branch pipe 27B. The cooled air is supplied from the air supply pipe 2B to the air manifold and air passages 35B of the fuel cell stack 39, and cools the fuel cell stack 39. The air flowrate at this time is preferably set to a lower flowrate than when the fuel cell stack 39 is generating power.

After the fuel cell stack 39 has stopped power generation, hydrogen remaining at the anode 32A is cooled by the cooled air of the air passages 35B. As a result of this cooling, water vapor contained in the residual hydrogen condenses. The condensed water accumulates on the surface and in the vicinity of the catalyst of the gas diffusion electrode of the anode 32A. Due to heat radiation and cooling of the fuel cell stack 39 which has stopped power generation, when the pressure of the hydrogen passages 35A and hydrogen manifold falls, air in the atmosphere is aspirated from the anode effluent pipe 3A into the hydrogen manifold or hydrogen passages 35A. Condensed water which has accumulated on the surface and in the vicinity of the catalyst of the gas diffusion electrode prevents the residual hydrogen at the anode 32A from starting a combustion reaction with the aspirated air. Therefore, there is no risk that the residual hydrogen will burn to damage the electrolyte membrane 31 after the fuel cell stack 39 has stopped power generation.

In a next step S3, as in the first embodiment, the controller 8 determines whether or not the temperature of the fuel cell stack 39 has fallen to the predetermined temperature.

If the temperature of the fuel cell stack 39 has fallen to the predetermined temperature, in a step S17, the controller 8 stops operation of the compressor 21 and blower 18. Also, the shutoff valve 28 is closed, and the three-way valve 29 is operated so that the cooling air passage 26 is opened to the vehicle compartment.

The processing of the next step S5 is identical to the processing of the step S5 of the first embodiment.

According to this embodiment, by using the air conditioning device 41 for the vehicle compartment, the fuel cell stack 39 can be cooled after power generation has stopped. Therefore, as in the first embodiment, combustion of residual hydrogen at the anode 32A can be prevented without supplying a coolant to the fuel cell stack 39.

In this embodiment, the recirculation passage 4 and related apparatuses which supply coolant to the fuel cell stack 39 are omitted, but the coolant passages 35C can of course be formed in the fuel cell 37 as in the first embodiment, and the power plant comprising the recirculation passage 4 which recirculates coolant to the fuel cell stack 39 can be combined with the air conditioning device 41 for the vehicle compartment. In this case, cooling after the fuel cell stack 39 has stopped power generation can be performed in a shorter time.

In this embodiment, the external power supply 9 or capacitor 13 may be used instead of the secondary battery 11. Further, the temperature sensor 10 identical to the first embodiment may also be used instead of the thermocouple 30.

### INDUSTRIAL FIELD OF APPLICATION

According to this invention, combustion of hydrogen remaining at the anode after the fuel cell has stopped power generation is prevented without purging residual hydrogen in the hydrogen passages. Therefore, a device for purging residual hydrogen is not required, and a particularly desirable result is obtained by applying the invention to a power plant installed in a limited vehicle space.

The contents of Tokugan 2003-328645, with a filing date of Sep. 19, 2003 in Japan, are hereby incorporated by reference.

Although the invention has been described above by reference to certain embodiments of the invention, the invention is not limited to the embodiments described above. Modifications and variations of the embodiments described above will occur to those skilled in the art, within the scope of the claims.

The embodiments of this invention in which an exclusive property or privilege is claimed are defined as follows:

1. A fuel cell power plant comprising:
at least one fuel cell comprising an anode, a cathode, and an electrolyte membrane gripped therebetween, the fuel cell generating an electric power by an electrochemical reaction through the electrolyte membrane of hydrogen supplied to the anode and oxygen supplied to the cathode, and
a device which condenses water vapor staying around at least the anode after the fuel cell has stopped power generation.

2. The power plant as defined in claim 1, wherein the condensing device is a cooling device which cools a fuel cell.

3. The power plant as defined in claim 2, wherein the power plant further comprises a sensor which detects a temperature of the fuel cell, and a programmable controller programmed to stop operation of the cooling device when the temperature of the fuel cell falls to a predetermined temperature.

4. The power plant as defined in claim 3, wherein the fuel cell is formed from a fuel cell which generates power within a temperature range from 60 degrees Centigrade to 90 degrees Centigrade and the predetermined temperature is set not higher than 60 degrees Centigrade.

5. The power plant as defined in claim 2, wherein the fuel cell further comprises a coolant passage which cools the anode and the cooling device comprises a coolant recirculation passage connected to the coolant passage, a heat exchanger which cools the coolant, and a pump which recirculates coolant cooled by the heat exchanger to the coolant passage via the recirculation passage.

6. The power plant as defined in claim 5, wherein the fuel cell further comprises a hydrogen passage which supplies hydrogen to the anode, the hydrogen passage being formed parallel to the coolant passage in the fuel cell, and the recirculation passage is connected to the coolant passage such that the coolant flow direction in the coolant passage is identical to the hydrogen flow direction in the hydrogen passage.

7. The power plant as defined in claim 2, wherein the power plant is installed in a vehicle, the vehicle comprises a vehicle compartment and an air conditioning device which supplies cooled air to the vehicle compartment, the fuel cell further comprises an air passage which supplies oxygen as air to the cathode, and the cooling device further comprises a device which supplies cooled air from the air conditioning device to the air passage.

8. The power plant as defined in claim 1, wherein the fuel cell further comprises a hydrogen passage which supplies hydrogen to the anode, and the power plant further comprises an outside air entry blocking device which blocks entry of outside air to the hydrogen passage after the fuel cell has stopped power generation.

9. The power plant as defined in claim 8, wherein the outside air entry blocking device comprises a valve which seals the hydrogen passage.

10. The power plant as defined in claim 9, wherein the outside air entry blocking device comprises a water trap which allows gas discharge from the hydrogen passage while blocking entry of gas to the hydrogen passage.

11. The power plant as defined in claim 10, wherein the outside air entry blocking device further comprises a valve which discharges gas discharged from the hydrogen passage into the atmosphere without passing through the water trap.

12. The power plant as defined in claim 1, wherein the fuel cell further comprises a hydrogen passage which supplies hydrogen to the anode, and the power plant further comprises a catalytic burner connected to the hydrogen passage which burns anode effluent discharged from the hydrogen passage.

13. The fuel cell power plant as defined in claim 1, wherein the power plant further comprises a separate charge storage device which supplies power to the condensing device.
